(19) United States
(12) Patent Application Publication
(10) Pub. No.: US 2006/0146289 A1
(43) Pub. Date: Jul. 6, 2006

(54) OPTICAL SYSTEM FOR PROJECTION DISPLAY APPARATUSES

(76) Inventors: Po Liang Chiang, Taipei City (TW); Yi Wei Liu, Taipei Hsien (TW); Hsin Wen Tsai, Taipei Hsien (TW); Hsueh-Chen Chang, I-Lan Hsien (TW); Ci Guang Peng, Chia-I City (TW)

Correspondence Address: NORTH AMERICA INTELLECTUAL PROPERTY CORPORATION, P.O. BOX 506, MERRIFIELD, VA, 22116, US

(21) Appl. No.: 10/905,398

(22) Filed: Dec. 30, 2004

(51) Int. Cl. G03B 21/14

(52) U.S. Cl. 353/20

(57) ABSTRACT

An optical system utilizing a unique polarizer separating plate to replace conventional PBS prism is disclosed. The optical system of this invention, which may be applied to projection display apparatuses such as rear projection type televisions, includes an illumination system for generating a homogeneous light beam, a polarizer separating plate comprising a polarization separation surface that splits the light beam into a first polarized light beam with a first polarization status and a second polarized light beam with a second polarization status, wherein the first polarized light beam propagates through a first aberration compensation lens to a first panel, and a second polarized light beam propagates through a second aberration compensation lens to a second panel. According to one embodiment, the polarizer separating plate includes two sheets of glass substrates having the same thickness and the polarization separation surface is sandwiched by the two sheets of glass substrates.

### BACKGROUND OF INVENTION

1. Field of the Invention

The invention relates to an optical system for projection display apparatuses, and more particularly, to an optical system that utilizes non-lead PBS prisms for projection display apparatuses with two-piece or three-piece Liquid Crystal Display (LCD) panels or Liquid Crystal on Silicon (LCoS) panels.

2. Description of the Prior Art

As technology advances, large screen and high quality projectors and projection televisions are gaining in popularity for satisfying the demands of consumers. Today, almost all projectors and projection televisions are installed with complex optical systems using the latest manufacture technology available, and in the design of optical systems, the elimination of geometric aberration has always been a critical task.

Please refer to FIG. 1. FIG. 1 is a diagram showing the optical system of a projection apparatus according to the prior art. As shown in FIG. 1, the optical system includes a polarizer beam separator (PBS) prism 10 that is capable of separating and combining light beams. Due to the fact that the PBS prism 10 is a symmetrical structure, the aberration compensation of the projection display apparatus of the prior art can be easily corrected via a projecting lens 12. As shown in the figure, the PBS prism 10 is comprised of two rectangular prisms 13 (symmetrical prisms at 90-45-45 degree angles). A beam splitting coating 14, coated in between the two prisms 13, allows the penetration of a polarized light beam 21 with the first polarization status, such as a P polarization beam, to the panel 15 and the reflection of the polarized light beam 22 with the second polarization status, such as an S polarization beam, to the panel 16.

Nevertheless, the optical system of a projection apparatus according to the prior art still has numerous disadvantages. First, an excessively low extinction ratio can easily result from utilizing the prior art PBS prism 10. In order to reduce the birefringence problem of light beams, the prior art PBS prism 10 is usually comprised of lead-contained glass substrates, which often cause environmental contaminations. In addition, the prior art PBS prism 10 also has a very large size and a high cost.

### SUMMARY OF INVENTION

It is therefore an objective of the present invention to provide an improved optical system for projection display apparatuses to utilize non-lead prisms that are not only smaller in size, but also cheaper to manufacture, thereby providing a much greater advantage in comparison to the prior art systems.

According to the present invention, the optical system of a projection apparatus comprises an illumination system for generating light beams; a polarizer separating plate comprising a polarization separation surface that enables the illumination system to split the light beam into a first polarized light beam with a first polarization status and a second polarized light beam with a second polarization status, wherein the first polarized light beam propagates to a first panel and the second polarized light beam propagates to a second panel; a first aberration compensation lens located between the polarizer separating plate and the first panel, wherein the first polarized light beam propagates through the first aberration compensation lens to the first panel; and a second aberration compensation lens located between the polarizer separating plate and the second panel, wherein the second polarized light beam propagates through the second aberration compensation lens to a second panel. The polarizer separating plate includes two glass substrates with the same thickness and material for holding the polarization separation surface there between.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram showing the optical system of a projection apparatus according to the prior art.

FIG. 2 is a diagram showing the optical system of a projection apparatus according to the first embodiment of the present invention.

FIG. 3 is a magnified cross-section of the polarizer separating plate according to the present invention.

FIG. 4 is a diagram showing the optical system of a projection apparatus according to the second embodiment of the present invention.

### DETAILED DESCRIPTION

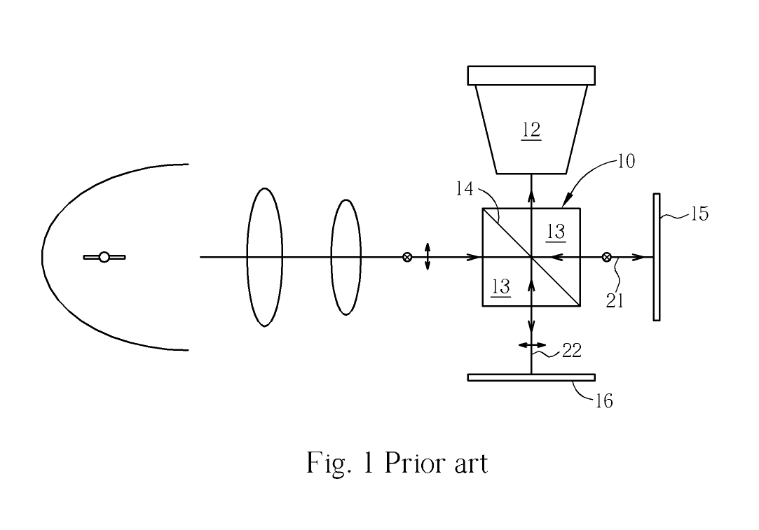

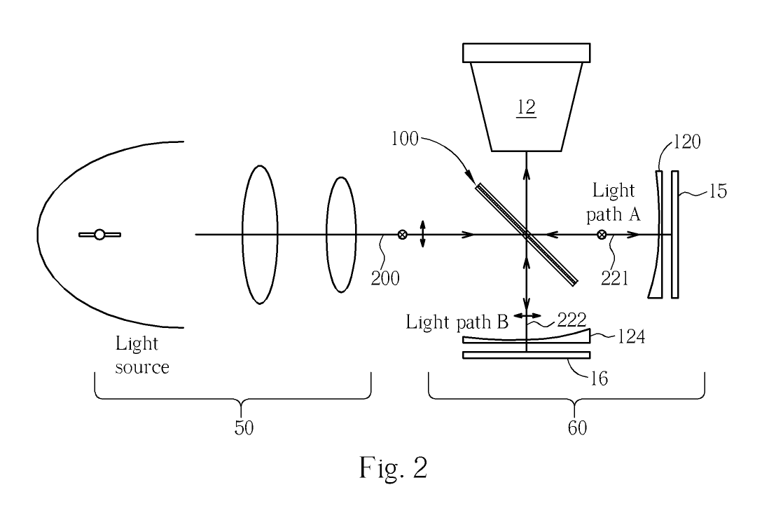

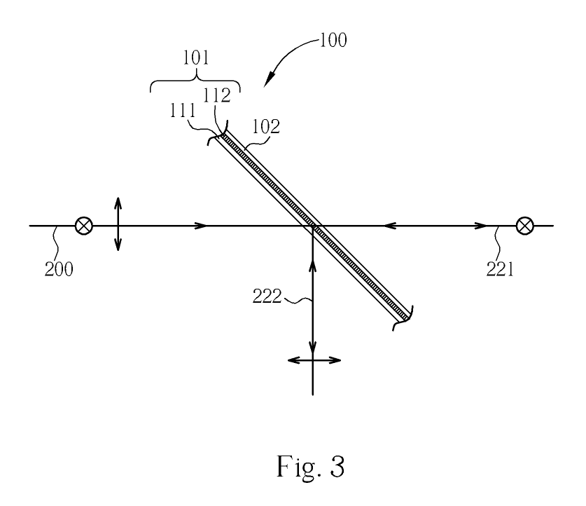

Please refer to FIG. 2 and FIG. 3. FIG. 2 is a diagram showing the optical system of a projection apparatus according to the first embodiment of the present invention. In FIG. 2, the same devices that are shown in FIG. 1 are represented by the same reference numbers. FIG. 3 is a magnified cross-section of the polarizer separating plate 100 according to the present invention.

Please refer to FIG. 2. As shown in FIG. 2, the optical system of the present invention includes two major components: the illumination system 50 and the optical engine 60. Similar to the prior art, the illumination system 50 includes a light source and a lens module. The focus of the present invention is to develop a polarizer separating plate 100 for replacing the prior art PBS prism. By illuminating the light beam 200 produced by the illumination system 50 onto the polarizer separating plate 100, the polarized light beam 221 with the first polarization status of the light beam 200, such as the P polarization beam is propagated via a light path A to the panel 15, and the polarized light beam 222 with the second polarization status, such as the S polarization beam is reflected via a light path B to the panel 16. Another characteristic of the present invention is that the polarized light beam 221 with the first polarization status is passed through a first aberration compensation lens 120 before reaching the panel 15, and the polarized light beam 222 with the second polarization status is passed through a second aberration compensation lens 124 before reaching the panel 16. The polarizer separating plate 100 is positioned in the middle of the light path at a 45 degree angle corresponding to the panel.

According to the first embodiment of the present invention, the panels 15 and 16 can be LCoS display panels. In addition, the present invention is not limited to the two piece panel architecture disclosed in FIG. 1, but can also be applied to a three piece (or a multi-piece) panel architecture.

Please refer to FIG. 3. As shown in FIG. 3, the polarizer separating plate 100 includes a polarization splitter plate 101, such as the polarization splitter produced by the Moxtek Inc, or a polarization beam splitter that has a high light extinction ratio and a low reflection loss. The polarization splitter plate 101 is comprised of a glass substrate 111, in which a plurality of silver or aluminum wire grids 112 is arranged in the single grid direction of the glass substrate 111 surface. The polarizer separating plate 100 also includes an optical path correction glass substrate 102 fixed on the surface of the glass substrate 111 and together with the optical path correction glass substrate 102, embraces the wire grids 112 there between. It should be noted that the thickness and material of the optical path correction glass substrate 102 is to be the same as the glass substrate 111 for correcting the light path produced as a result of refraction.

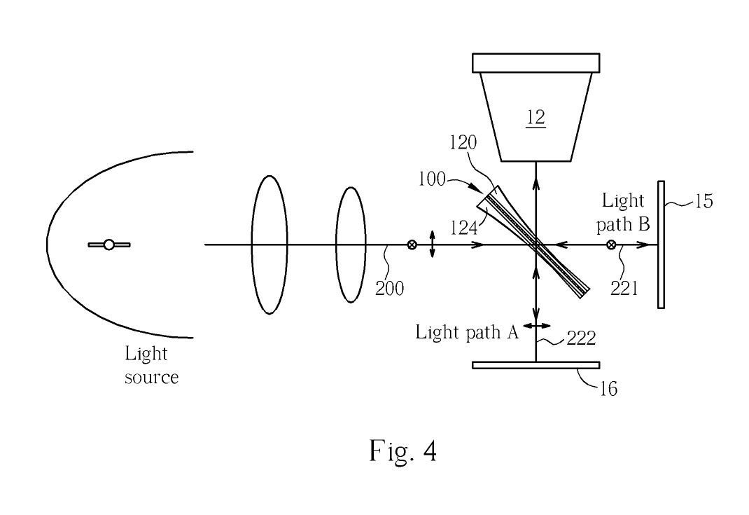

According to the embodiments of the present invention, the first aberration compensation lens 120 and the second aberration compensation lens 124 can be plate-type lenses, wedge-shape lenses, spherical glass substrates, non-spherical glass substrates, or cylindrical glass substrates. Please refer to FIG. 4. FIG. 4 is a diagram showing the optical system of a projection apparatus according to the second embodiment of the present invention. As shown in FIG. 4, the first aberration compensation lens 120 and the second aberration compensation lens 124 can be bound directly with the polarizer separating plate 100, whereas in other embodiments, the first aberration compensation lens 120 and the second aberration compensation lens 124 can be bound with other corresponding panels.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical system of a projection apparatus comprising:
an illumination system for generating light beams;
a polarizer separating plate comprising a polarization separation surface that enables the illumination system to split the light beam into a first polarized light beam with a first polarization status and a second polarized light beam with a second polarization status, wherein the first polarized light beam propagates to a first panel and the second polarized light beam propagates to a second panel;
a first aberration compensation lens located between the polarizer separating plate and the first panel, wherein the first polarized light beam propagates through the first aberration compensation lens to the first panel; and
a second aberration compensation lens located between the polarizer separating plate and the second panel, wherein the second polarized light beam propagates through the second aberration compensation lens to a second panel.

2. The optical system of claim 1 wherein the polarizer separating plate includes two glass substrates of the same thickness and material for holding the polarization separation surface there between.

3. The optical system of claim 1 wherein the polarizer separating plate includes a polarization splitter plate comprised of a glass substrate, in which a plurality of silver or aluminum wire grids are arranged in the single grid direction of the glass substrate surface, and an optical path correction glass substrate fixed on the surface of the glass substrate and together with the glass substrate, embraces the wire grids there between.

4. The optical system of claim 3 wherein the wire grid is comprised of silver or aluminum.

5. The optical system of claim 1 wherein the first panel is a liquid crystal on silicon (LCoS) panel.

6. The optical system of claim 1 wherein the second panel is a liquid crystal on silicon (LCoS) panel.

7. The optical system of claim 1 wherein the first aberration compensation lens can be a plate-type lens, a wedge-shape lens, a spherical glass substrate, a non-spherical glass substrate, or a cylindrical glass substrate.

8. The optical system of claim 1 wherein the second aberration compensation lens can be a plate-type lens, a wedge-shape lens, a spherical glass substrate, a non-spherical glass substrate, or a cylindrical glass substrate.

9. The optical system of claim 1 further comprising a projection lens in which no aberration compensation lens is placed in between the projection lens and the polarizer separating plate.
